(19) United States
(12) Patent Application Publication
(10) Pub. No.: US 2025/0020922 A1
(43) Pub. Date: Jan. 16, 2025

(54) SELECTIVE VOLUME HOLOGRAPHIC WAVEGUIDE

(71) Applicant: ams International AG, Jona (CH)

(72) Inventors: Robin KAECH, Ecublens (CH); Frederic MONTFORT, Froideville (CH); Marie AUBRY, Echichens (CH); Carlos MACIAS, Pully (CH)

(21) Appl. No.: 18/711,881

(22) PCT Filed: Oct. 24, 2022
(86) PCT No.: PCT/EP2022/079528

§ 371 Date: May 21, 2024

(30) Foreign Application Priority Data
Nov. 22, 2021 (GB) 2116788.7

(51) Int. Cl. G02B 27/01; G03H 1/02

(52) U.S. Cl. CPC G02B 27/0103; G03H 1/0248

(57) ABSTRACT

The present disclosure provides a waveguide device for generating an eyebox of a display, the waveguide device including: a first volume phase holographic, VPH, grating configured to selectively diffract incident light according to a wavelength and/or an angle of incidence on the first VPH grating to incouple the diffracted incident light into the waveguide device, one or more second VPH gratings configured to selectively diffract the incoupled light according to a wavelength and/or an angle of incidence to direct the incoupled light through the waveguide device; and one or more third VPH gratings configured to selectively diffract the light propagating in the waveguide device according to a wavelength and/or an angle of incidence to outcouple said propagating light, wherein collectively each beam of outcoupled light generates said eyebox.

### FIELD

The present disclosure relates to a waveguide device for generating an eyebox of a display, and an optical system and a heads-up display comprising such a waveguide device.

### BACKGROUND

Optical devices such as off-axis retinal scanning displays (ORSDs) are a type of display that are used in virtual and augmented reality applications such as in wearable heads-up displays. They are designed to allow a user to see projected content in their field of view in a manner that allows the user to continue to see their external environment as well. ORSDs work by using a projector secured to a user's head to project an image onto the retina of the user which causes the user to see displayed content floating in space in front of them.

The projector is attached to the side of (i.e. off-axis to) a wearable frame or structure, for example a headset, helmet or glasses frame with eye pieces, or in the case of a heads up display in a vehicle mounted in the vehicle. The eye pieces are provided with a holographic combiner which are illuminated by the projector. The illuminated holographic combiners cause the image to be projected through the user's pupil onto their retina.

As is known in the field, in optical devices such as ORSDs and other types of heads up displays and AR/VR devices, the term “eyebox” refers to a volume of space relative to the device in which the user has to position their eye to be able to correctly see the full, projected image. If a device has a small eyebox, the range of eye positions at which the user can correctly see the full image is small. If a device has a large eyebox, the range of eye positions at which the user can correctly see the full image is greater which thus provides a better user experience. If the user moves their eye position outside of the eyebox, they will see only part of the projected image or not see it at all. This is because it is only in the eyebox that the user's pupil and thus retina is correctly aligned with the optical path of the light projected by the device. It is also known that the gaze direction of a user can effect whether or not the user's pupil lines up with the optical path of the light projected by the device, particularly where the eyebox is small and only covers the eye position of a user gazing directly ahead. Ensuring that the device has an eyebox having a size that provides a good user experience requires the expansion of the eyebox (typically in two dimensions e.g. along vertical and horizontal axes with respect to the alignment of the device worn by the user). This is known in the field as eyebox expansion.

One way to achieve eyebox expansion is to use pupil replication. As is known in the field, the term “pupil” in pupil replication refers to copying the exit pupil of the optical system, that is, a copy of the full image being projected. Pupil replication works by replicating the full image a number of times and projecting each copy to a different position in front of the user's eye. As long as one of the replicated pupil's overlaps with the pupil of the user's eye, at least one copy of the image will be projected onto the user's retina and the user will be able to see the projected image correctly. This has the effect of increasing the size of the eyebox as the user's eye can be in any position where there is overlap with at least one replicated pupil.

A known waveguide combiner used in optical devices is a surface relief grating (SRG) waveguide arrangement. This consists of a waveguide whose surface is provided with SRGs, typically three linear gratings: one for incoupling of incident light into total internal reflection, one for generating eyebox expansion in one dimension, and one for expanding the eyebox in the second dimension and outcoupling of the light propagating internally in the waveguide to project the light out of the waveguide. The total internal reflection propagation of the incident light causes it to split many times on each reflection off the SRGs in one or two dimensions. Upon outcoupling, the many-times split beams flood the image area in indiscriminate directions thereby providing a flood-like illumination to achieve a large eyebox with illumination levels high enough to provide an acceptable user experience.

Using SRG waveguides as a combiner has the benefit of creating a large eyebox with a reasonable field of view. However, they are not efficient and typically have high losses. This is primarily because, in order to produce said eyebox, SRG waveguides diffract the light indiscriminately at each point on the grating, regardless of input angle. Only a limited zone in front of the outcoupling SRG contains the full field of view, but the outcoupling SRG emits light in all directions. This results in a large proportion of outcoupled light being wasted because it contributes to partial fields of view around the eyebox instead of to the full field of view in the eyebox.

Further, SRGs also outcouple light in directions directly away from the user (e.g. on the “world side” of the device instead of on the side of the device facing the user). Not only is this another source of efficiency loss, but it may generate unwanted luminescence towards the world side which is distracting for anyone on the world side who will see a glow being emitted towards them.

U.S. Ser. No. 10/690,916B2 and US2021/0231961A1 propose the use of volume phase holographic (VPH) gratings that serve the same purpose as the SRGs by incoupling incident light into free-form total internal reflection described above to generate a flood-like illumination on outcoupling whereby much of the outcoupled light is wasted and does not contribute to the eyebox.

### SUMMARY

In general terms, the present disclosure overcomes the above and other problems by providing a waveguide device one or multiple layers each containing at least three VPH gratings (an incoupling grating, a fold or propagation grating and an outcoupling grating), these may optionally be laminated on a surface of the waveguide device. This provides a one-to-one input to exit design that is more flexible than known systems and that accordingly allows for the expansion of eyebox size by different means. For example, reducing the angle and/or wavelength selectivity of one or more of the VPH gratings pushes the system to a more flood-like illumination output akin to SRG waveguide system behaviour. Alternatively, eyebox expansion may be achieved by multiplexing VPH gratings to provide pupil expansion. This allows the waveguide device of the present disclosure to provide better control of the efficiency versus eyebox size trade off not provided by known systems.

Thus, according to a first aspect of the disclosure, there is provided a waveguide device for generating an eyebox of a display, the waveguide device comprising: a first volume phase holographic, VPH, grating configured to selectively diffract incident light according to a wavelength and/or an angle of incidence on the first VPH grating to incouple the diffracted incident light into the waveguide device, one or more second VPH gratings configured to selectively diffract the incoupled light according to a wavelength and/or an angle of incidence to direct the incoupled light through the waveguide device; and one or more third VPH gratings configured to selectively diffract the light propagating in the waveguide device according to a wavelength and/or an angle of incidence to outcouple said propagating light, wherein collectively each beam of outcoupled light generates said eyebox.

As explained above, known SRG waveguide systems rely on a flood-like illumination to achieve a large eyebox, in the sense that the totally internally reflected light propagating in the waveguide is split each time it bounces off an SRG layer thereby flooding the eyebox. Such a system may be said to be a one-to-many input to exit system whereby each input beam is split into many output beams, only some of which contribute to the eyebox, the others being wasted. Each input beam in such arrangements has many available optical pathways through the waveguide device and these are independent of wavelength and/or angle of incidence. It is not possible to easily control the optical efficiency to eyebox size trade off in such waveguide systems.

In contrast and advantageously, using a VPH layer for each of: (i) incoupling, (ii) propagation in the waveguide device through total internal reflection, and (iii) outcoupling provides a one-to-one input to exit system. Specifically, each input beam will have a one-to-one correspondence with a corresponding output beam because of the wavelength and/or angle selectivity of the VPH gratings. That is, the waveguide device is tuned according to the Bragg selectivity of the VPH gratings rather than tuned to have a specific optical function. As a result, all of the input light contributes to the eyebox at the output of the system thereby providing a more efficient optical system that provides an improved trade-off of eyebox size against efficiency compared to known systems.

In other words, each grating is not only optically recorded to achieve high diffraction efficiency with a position dependent angular and wavelength bandwidth, but each beamlet is assigned a single optical path from entrance to exit pupil of the system.

Thereby guaranteeing that the exiting beam will be contributing to the eyebox rather than being wasted for example because it exits the system in a direction away from the eyebox position. These ideal paths locally define the selectivity conditions everywhere on the VPH gratings and are calculated before the manufacture of the VPH gratings so that they can be recorded during manufacture.

This approach also allows eyebox expansion to be achieved in unique ways, for example, by broadening the angle selectivity of the second and third VPH gratings through VPH design (e.g. by tuning the VPH thickness, for example by using a thicker VPH grating to increase angle selectivity or decreasing thickness of the VPH gratings to reduce angle selectivity or by increasing the refractive index modulation as part of hologram recording).

For example, the first, incoupling VPH grating can remain very selective (e.g. angle and/or wavelength selective) for an input beam with a single entrance pupil, or it can have a broader selectivity if e.g. the input source already possesses a pupil expansion/replication scheme. An incoupling VPH grating with high selectivity also ensures that no light is wasted as the light entering the waveguide device cannot use the incoupling VPH grating to exit the waveguide after an initial rebound or back-reflection upon entry into the waveguide device which is something that occurs when using SRG gratings to incouple light. It is envisaged that the incoupling VPH grating provides a point to freeform optical function.

It is envisaged that the first (incoupling), second (fold, propagation) and third (outcoupling) VPH gratings may be highly selective to provide the desired one-to-one input to exit system. Thus, in some implementations, the wavelength and/or angle selectivity of the first, second and third VPH gratings provides a single optical path through the waveguide device for each wavelength and/or angle of incidence of a beam of light incident on the first VPH grating

Advantageously, a highly selective set of first, second and third VPH gratings provides only a single optical path through the waveguide device for a corresponding single input wavelength and/or angle of incidence. In other words, only a beam of light having the correct wavelength and angle of incidence will be able to follow that single optical path through the waveguide device to be correctly incoupled, propagated and outcoupled in the correct direction. However, when a beam of light does have the correct wavelength and angle of incidence, it will effectively propagate through the waveguide device with zero, minimal or, at the very least, reduced losses and contribute fully to the generation of the eyebox without any or only minimal wastage.

Alternatively, the first, second and third VPH gratings may have less selectivity whereby the wavelength and/or angle selectivity tuning effectively trades off eyebox size with luminous intensity. That is, a lower selectivity expands the eyebox in the manner that a SRG grating would but in doing so lowers luminous intensity whereas higher selectivity tunes the waveguide device to produce a strict one-to-one input to exit correspondence for each wavelength and/or angle of incidence with very little or no wasted light but a smaller eyebox.

Optionally, a Bragg selectivity of the first, second and/or third VPH gratings determines a size of the generated eyebox. For example, the Bragg selectivity of the first, second and/or third VPH gratings is determined by a thickness of the material first, second and/or third VPH gratings. Alternatively or additionally, the Bragg selectivity of the first, second and/or third VPH gratings is determined by an exposure saturation of the material of the first, second and/or third VPH gratings during manufacture. For example, by increasing the exposure saturation while illuminating a holographic recording medium with a beam of interest and reference beam to generate an interference pattern in the recording medium during manufacture of the VPH grating.

Optionally, the first, second and/or third VPH gratings comprise linear VPH gratings. That is the VPH gratings have the same pitch along their whole surface, in other words they have a constant surface periodicity. The first VPH, incoupling grating may have a non-linear surface pitch, for example in cases where incident light is already collimated, however it should redirect the incident light into total internal reflection in the same manner as e.g. a spherical or point input. As will be described below, Optionally, at least two of the one or more second VPH gratings are multiplexed together, and/or at least two of the one or more third VPH gratings are multiplexed together.

Optionally, the presence of multiple second and third VPH gratings causes the waveguide device to define a plurality of exit pupils, each exit pupil associated with a corresponding pair of the second and third VPH gratings. The multiplexing of the VPH gratings referred to herein refers to angular multiplexing and/or wavelength multiplexing depending on the context.

Advantageously, multiplexing multiple VPH gratings in the same recording medium allows the waveguide to provide eyebox expansion in two dimensions without the need for other, bulkier optical components or elements that are typically required for eyebox expansion. This eyebox expansion through multiplexing may be in addition to the eyebox expansion by broadening angle selectivity of the second and third VPH gratings through VPH design described. For example, in the case of eyebox expansion through pupil replication, each additional pair of second and third VPH gratings multiplexed into the recording medium provides a new optical path to a new exit pupil whereby the number of exit pupils can accordingly be increased by increasing the number of multiplexed second and third VPH gratings. Multiplexing the second and third VPH gratings may also be used to achieve local selectivity broadening which also results in an expanded eyebox.

Optionally, the waveguide device comprises a plurality of sets of said first, second and/or third VPH gratings. These may optionally be provided in a tiled arrangement in the waveguide device.

Advantageously, the tiling arrangement described herein enables the waveguide device to reach significantly higher field-of-views than known systems. This is because each tile acts as a sub-system which can handle a portion of the total field of view. Thus, dividing the total field of view into smaller field of views each corresponding to a tile associated with a set of first, second and/or third VPH gratings. For example, depending on the system minimal refractive index, a 2×2 tiling arrangement may provide a 60-80 degree field of view, preferably a 70 degree field of view. Increasing the tiles to a 3×3 arrangement increases the field of view to 90-110 degrees, preferably a 100 degree field of view. Accordingly it is envisaged that increasing the number of tiles increases the field of view.

Optionally, the pitches and/or pitch orientations of the first, second and/or third VPH gratings in each set of the tiled arrangement are different to each other.

Advantageously, when the field of view is tiled as described above, providing a different pitch and/or pitch orientation, for example by providing each of the corresponding VPH gratings in each set with a different number of fringes per mm relative to each other and/or a different directionality relative to each other, further improves the ability of the tiling arrangement to reach the above-described improved field of views of between 60-80 degrees (preferably 70 degrees) for the 2×2 tiled arrangement or between 90-110 degrees (preferably 100 degrees) for the 3×3 tiled arrangement without compromising on efficiency. This contrasts with known applications of VPH gratings where linear gratings are used where the pitch and pitch orientations of all the gratings is the same. Thus, the pitch and/or pitch orientation of the first VPH grating in a first set is different to the pitch and/or pitch orientation of the first VPH grating in a second set, the pitch and/or pitch orientation of the second VPH grating in the first set is different to the pitch and/or pitch orientation of the second VPH grating in the second set, and the pitch and/or pitch orientation of the third VPH grating in the first set is different to the pitch and/or pitch orientation of the third VPH grating in the second set, and so on for each set of VPH gratings. It is envisaged in some cases, for example if two tile sets are symmetrical, that a number of the VPH gratings may share the same pitch value, but the pitch orientation, could be different (i.e. the same pitch value but rotated differently).

As will be appreciated, the pitch and/or pitch orientation of a VPH grating defines its k-vector. The pitch and/or pitch orientation of each of the VPH gratings in a tile set may be configured so that the sum of the k-vectors of the VPH gratings together in the set is zero. Effectively, this means that the effects the VPH gratings impart onto the propagating light cancel each other out, thereby providing the desired image at the output without unwanted distortion.

Thus, optionally, the pitch and/or pitch orientations define a k-vector of each of the first, second and/or third VPH gratings in each set of the tiled arrangements, and wherein the sum of the k-vectors in each set is zero.

Optionally each set of first, second and third VPH gratings may be configured to selectively diffract incident light of a different wavelength.

Advantageously, this enables colour multiplexing to take place. That is, to minimise chromatic aberrations at the eyebox, incident light of different wavelengths may need to be provided with a different, customised optical path through the waveguide device. Accordingly, each layer of first, second and third VPH gratings selectively diffracts light of only one or a range of predetermined wavelengths thereby providing a one-to-one optical path through the system not only according to angle of incidence but also according to wavelength. For example, if there are two input wavelengths (e.g. a wavelength corresponding to red and a wavelength corresponding to green), then six VPH gratings are provided two layers, grouped into sets of three.

Optionally, the first, second and third VPH gratings in at least two sets of the plurality of sets are multiplexed together and/or the plurality of sets of first, second and third VPH gratings may be provided in a layered arrangement.

Advantageously, this reduces the space requirements of the waveguide device as multiple VPH gratings may be recorded in a multiplexed manner in the same medium. For example, in a full red, green, blue (RGB) polychromatic system, the red and blue wavelength VPH gratings may be multiplexed together while the green wavelength VPH grating is kept in a separate layer or vice versa. Synergistically, combining a layered arrangement with the tiled arrangement described above provides a much greater degree of design freedom of the waveguide device. For example, the field of view can be expanded by using a tiled arrangement and then also overlaying multiple layers in a manner that the tiles do not overlap with each other to thereby cover a full field of view while at the same time, red, green and blue wavelength VPH gratings can be layered to make such a system fully polychromatic.

Optionally, the first, second and third VPH gratings are arranged at a first surface of the waveguide device, optionally laminated on the first surface of the waveguide device. For example, as described below, this may be on the “world” side of the waveguide device or the user or “eye” side of the waveguide device.

Advantageously, providing the VPH gratings on a surface and providing the VPH grating with suitable angle and/or wavelength selectivity ensures that no unwanted losses occur as compared to SRG gratings which have no selectivity and diffraction orders on both the “world” and “eye” sides. In particular, VPH gratings have only defined diffraction orders and accordingly suitable angle and/or wavelength selectivity prevents any unwanted diffraction orders that SRG gratings suffer from. In the example of an AR/VR headset, providing the VPH gratings as reflection mode gratings laminated on the world-side of an eyepiece and providing suitable angle and/or wavelength selectivity ensures that only the desired diffraction orders occur, thereby minimising losses, for example by minimising unwanted light emissions on the world-side which would otherwise be distracting to anyone interacting with the wearer of the AR/VR device. The VPH gratings may also be provided on the user or “eye” side of the waveguide device or may be provided embedded in the middle of the waveguide device. However, these “eye” side and embedded embodiments are not preferred.

Thus, according to a second aspect of the present disclosure, there is provided, an optical system for a heads-up display, the optical system comprising: an image projector configured to project an image towards an eye of a user; and a combiner element comprising the waveguide device of any preceding claim positioned in a field of view of the user and in an optical path between the image projector and the eye of the user.

Optionally, the first, second and third VPH gratings are laminated on a surface of the combiner element facing away from the user to prevent any light being emitted to the world-side of the optical system.

According to a third aspect of the present disclosure, there is provided a heads-up display comprising: the optical system described above; and a support frame for mounting the optical system. Optionally, the display comprises a wearable off-axis retinal scanning display.

### BRIEF DESCRIPTION OF THE DRAWINGS

These and other aspects will now be described, by way of example only, with reference to the accompanying figures in which:

FIG. 1a illustratively shows a known SRG waveguide device.

FIG. 1b illustratively shows a different view of a known SRG waveguide device.

FIG. 1c illustratively shows a known outcoupling SRG of the waveguide device of FIG. 1b.

FIG. 2a illustratively shows a waveguide device according to the present disclosure.

FIG. 2b illustratively shows a waveguide device according to the present disclosure.

FIG. 2c illustratively shows a waveguide device according to the present disclosure

FIG. 2d illustratively shows a waveguide device according to the present disclosure

FIG. 3a illustratively shows a tiled arrangement of VPH gratings according to the present disclosure.

FIG. 3b illustratively shows a tiled arrangement of VPH gratings according to the present disclosure.

FIG. 3c illustratively shows a tiled arrangement of VPH gratings according to the present disclosure.

FIG. 3d illustratively shows a tiled arrangement of VPH gratings according to the present disclosure.

FIG. 3e illustratively shows a tiled arrangement of VPH gratings according to the present disclosure.

FIG. 4 illustratively shows a stacked and tiled arrangement according to the present disclosure.

### DETAILED DESCRIPTION OF THE DRAWINGS

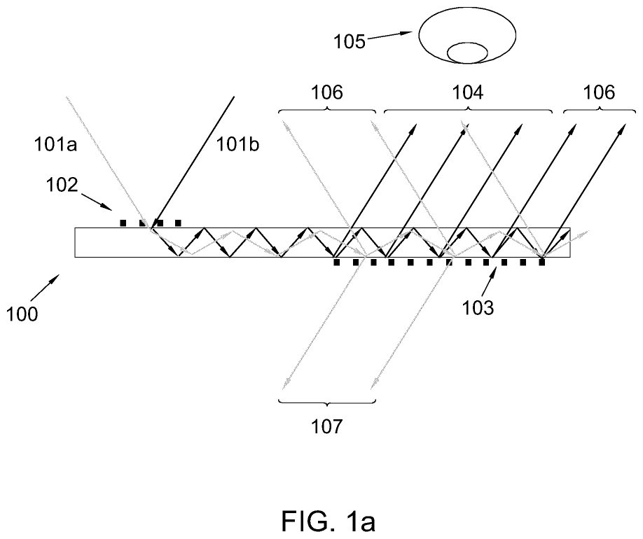

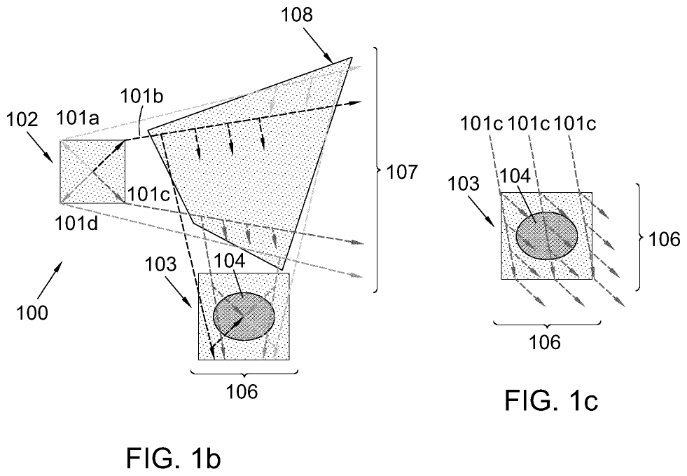

FIG. 1a illustratively shows a known SRG waveguide device 100. Two beams of light 101a, 101b are shown incident on an incoupling SRG 102 of the waveguide device 100 which incouple the light beams 101a, 101b into total internal reflection in the waveguide device. After a distance, the propagating light beams 101a, 101b reach an outcoupling SRG 103. Each reflection from the SRG splits the light beams 101a, 101b into outcoupled light beams propagating in many, uncontrolled directions. Some of these contribute to an eyebox 104 which a user 105 is able to see. Others propagate away from the eyebox either as wasted light 106 on the user side or as wasted light 107 on the world side which can cause a distraction for anyone interacting with the user. This flood-type illumination expands eyebox size but is also highly inefficient.

FIG. 1b illustratively shows a different view of a known SRG waveguide device. Like-numbered reference numerals refer to like-features. As in FIG. 1a, a number of input beams of light 101a, 101b, 101c, 101d are incoupled with an incoupling SRG and propagate through the device by total internal reflection. A further SRG 108, sometimes referred to as a fold grating provides eyebox expansion in a first direction by indiscriminately replicating the beams with each reflection irrespective of angle and/or wavelength. These replicated beams then propagate to the outcoupling SRG 103 where they are again replicated indiscriminately with each reflection irrespective of angle or wavelength in a second direction to the first, and outcoupled to generate an eyebox 104. However, as shown in FIG. 1a, only a portion of the light contributes to the eyebox 104. A great deal of it is wasted light 106 due to its propagation in directions away from the eyebox.

FIG. 1c illustratively shows the outcoupling SRG 103 which expands the eyebox 104 in a second direction by replicating the already replicated beams 101c with each reflection. FIG. 1c illustrates that the lack of wavelength or angle selectivity results in a high proportion of wasted light 106.

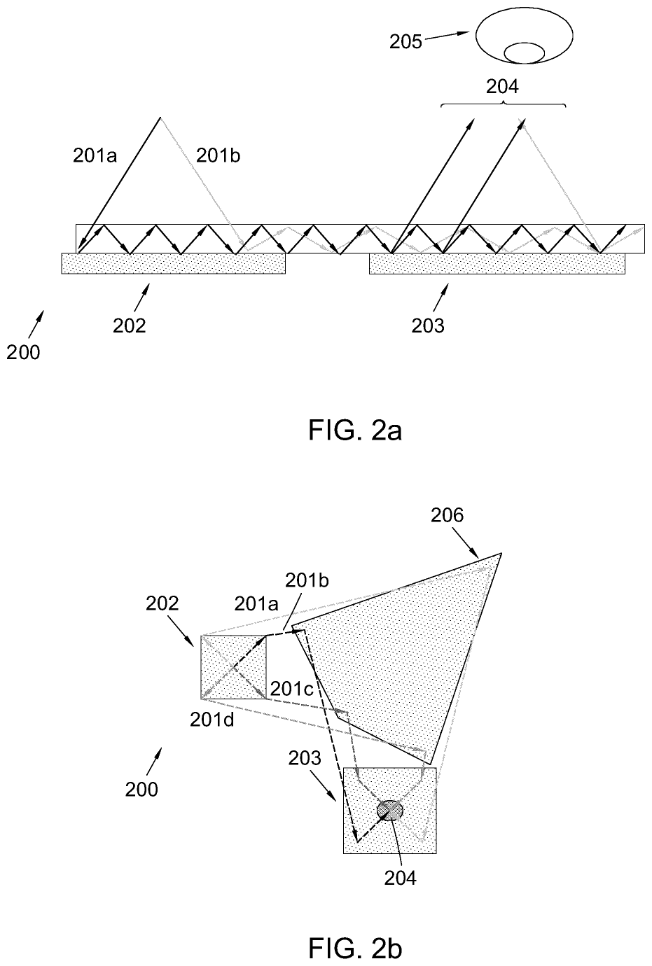

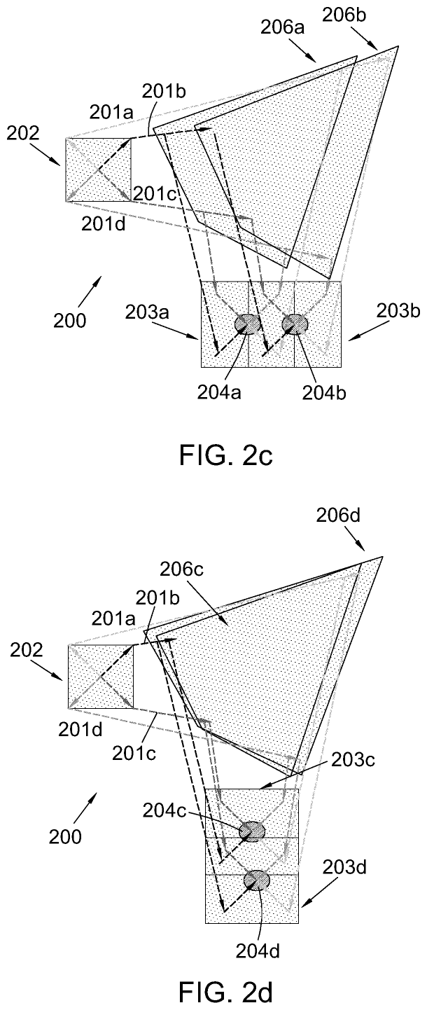

FIG. 2a illustratively shows a waveguide device 200 according to the present disclosure. Like-numbered reference numerals refer to like-numbered elements. Two beams of light 201a, 201b are shown incident on an incoupling VPH grating 202 of the waveguide device 200 which selectively incouple the light beams 201a, 201b into total internal reflection in the waveguide device 200 only when they have an angle of incidence and/or wavelength that matches the selectivity of the incoupling VPH grating 202. As described above, the selectivity may be high so that the risk of bounce back or outcoupling of the incoupled light through the VPH grating 202 is reduced.

After a distance, the propagating light beams 201a, 201b reach an outcoupling VPH grating 203 which selectively outcouple the light beams 201a, 201b to direct them to towards the eyebox only when they have an angle of incidence and/or wavelength that matches the selectivity of the outcoupling VPH grating 203. Once outcoupled, the outcoupled light beams 201a, 201b generate an eyebox 204 for a user 205 to view. As described above, the selectivity may be high to provide a strict one-to-one input to exit system or may be reduced to expand the eyebox 204 by directing additional light beams of a range of angles and/or wavelengths towards the eyebox 204.

It can be seen from a comparison of FIG. 2a with FIG. 1a that significantly less light is wasted because of the ability to control propagation of the light in the waveguide device through the use of the angle and wavelength selectivity of the VPH gratings.

FIG. 2b illustratively shows a different view of the waveguide device 200 of FIG. 2a. Like-numbered reference numerals refer to like-numbered elements. As in FIG. 2a, a number of input beams of light 201a, 201b, 201c, 201d are incoupled with an incoupling VPH grating 202 and propagate through the device by total internal reflection. A fold VPH grating 206 may provide eyebox expansion in a first direction. In the example of FIG. 2b, this may be achieved for example by reducing the selectivity of the fold VPH grating. This changes the waveguide from a strict one-to-one input to exit design with reduced losses compared to a system where the eyebox is expanded unselectively (i.e. not dependent on angle of incidence and/or wavelength) to one where the eyebox is expanded with some losses. Advantageously, the use of VPH gratings allows this trade off to be a controlled choice as opposed to being an uncontrollable property of the system about which nothing can be done. Alternatively, it is also envisaged that an ideal one-to-one input to exit design may be used whereby the eyebox is not substantially expanded but losses are reduced. The selectivity of the fold VPH grating 206 can thus be chosen to match a desired eyebox expansion versus optical efficiency trade off.

As can be seen in FIG. 2b, the propagating light beams 201a, 201b, 201c, 201d eventually reaches the outcoupling VPH grating 203 where they are selectively outcoupled and directed to the eyebox 204 only when an angle and/or wavelength matches the selectivity of the outcoupling VPH grating 203. As with the fold grating VPH grating 206, the selectivity of the outcoupling VPH grating 203 may be relatively high which results in a strict one to one input to output waveguide device reduced losses. Alternatively, if eyebox expansion is desired, the angle and or wavelength selectivity may be reduced to provide some eyebox expansion. Advantageously, as described above with the fold VPH grating 206, providing a VPH outcoupling grating 203 allows this trade-off between optical efficiency and eyebox expansion to be a controlled choice as opposed to property of the system about which nothing can be done.

As can be seen by comparing FIG. 2b with FIG. 1b, the VPH gratings do not indiscriminately replicate beams on each reflection as occurs in SRGs. Thus, the wasted light 106, 107 shown in FIGS. 1b and 1c does not occur in the waveguide device 200 of the present disclosure. Instead, the selective propagation according to angle and/or wavelength provided by the selectivity of the VPH gratings ensures that the optical path of each beam or combination of beams is known and controlled by intentional design and does not suffer from the indiscriminate propagation of light in SRG based waveguides that result in a high amount of wasted light.

FIGS. 2c and 2d show a waveguide device 200 according to the present disclosure. Like-numbered reference numerals refer to like-numbered elements. The waveguide device 200 shown in FIGS. 2c and 2d is the same as that shown in FIG. 2b except that a plurality of fold VPH gratings 206a, 206b, 206c, 206d and outcoupling VPH gratings 203a, 203b, 203c, 203d are provided. These are optionally multiplexed in the same recording medium or one or more layer thereof and thus, whilst shown separately in FIGS. 2c and 2d, when multiplexed they coexist in the same physical space.

Providing a plurality of fold VPH gratings 206a, 206b, 206c, 206d and corresponding outcoupling VPH gratings 203a, 203b, 203c, 203d provides for a corresponding number of new, angle and/or wavelength dependent optical paths through the waveguide device. That is, only light beams having an angle and/or wavelength matching the selectivity of at least one of the corresponding plurality of VPH gratings will propagate through the waveguide device along the desired optical path to be outcoupled by a corresponding one of the outcoupling VPH gratings 203a, 203b, 203c, 203d and to contribute to the target eyebox 204a, 204b, 204c, 204d associated with a given outcoupling VPH grating 203a, 203b, 203c, 203d. In this way, the plurality of fold VPH gratings 206a, 206b, 206c, 206d and outcoupling VPH gratings 203a, 203b, 203c, 203d collectively allow pupil replication in the vertical and horizontal directions to take place to expand the eyebox in a way that is optically efficient while remaining spatially compact.

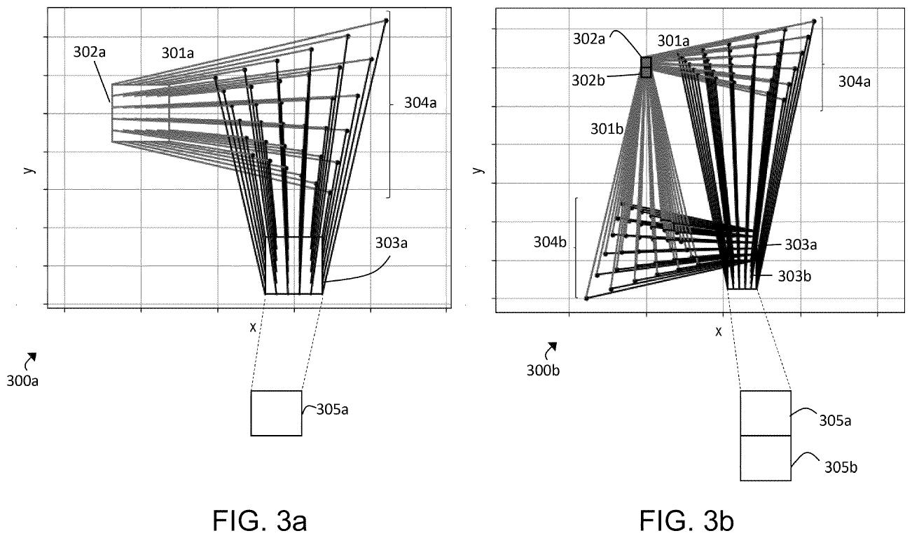

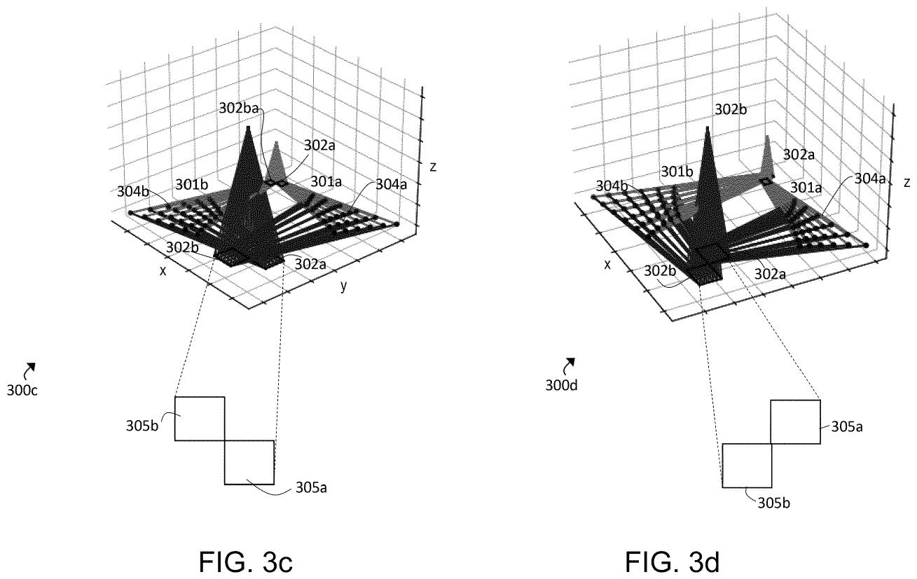

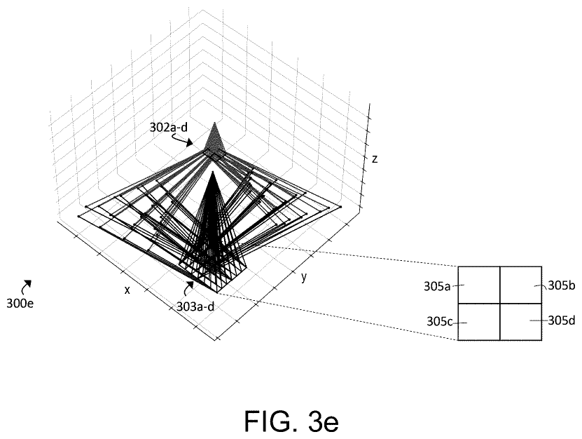

FIGS. 3a-3e illustratively show tiled arrangements of VPH gratings according to the present disclosure. Specifically, FIGS. 3a-3e show how the VPH gratings may be provided in a tiled arrangements to divide a field of view collectively among them to thereby enable an increased total field of view of the waveguide device. Like-numbered reference numerals refer to like-numbered elements.

FIG. 3a shows a single tile arrangement 300a with one-to-one input to output optical paths, that is each individual beam has only a single available path from the incoupling VPH grating through the waveguide device to the outcoupling VPH grating based on its specific wavelength and/or incident angle. The x and y axes indicate generic, spatial dimensions of the waveguide device and the distances the light has to propagate therethrough, the exact dimensions will be application dependent as will be appreciated by the skilled person. For example, the dimensions when used on an eyepiece of an AR/VR headset will differ to those when used on a heads-up display of a vehicle. The incoupling VPH grating 302a incouples beams of light 301a that propagate through the waveguide device and the fold VPH grating 304a to the outcoupling VPH grating 303a. The active zone footprint, i.e. the size of the active area in front of the user's eye, of such an arrangement thus comprises a single tile 305a matching the dimensions of the incoupling and outcoupling VPH grating.

FIG. 3b shows a 2×1 tile arrangement 300b whereby each incoupling VPH grating 302a, 302b has a corresponding fold VPH grating 304a, 304b and outcoupling VPH grating 303a, 303b whereby again each individual beam of the light 301a, 301b incoupled by a respective incoupling VPH grating 302a, 302b has only a single available path through the waveguide device to a respective outcoupling VPH grating 303a, 303b. As above, the x and y axes indicate generic spatial dimensions of the waveguide device and the distances the light has to propagate therethrough, the exact dimensions being application dependent as will be appreciated by the skilled person. The footprint of such an arrangement thus comprises two tiles 305a, 305b arranged in a column-like shape. The light 301a, 301b propagating along the two different paths provides the advantage that there is no or very little cross talk between them. As described above, providing a plurality of sets of VPH gratings in this way allows the full field of view to be divided along one direction, in this case the y-direction. For example, having two sets of tiles allows the field of view along the y-direction to be increased. As will be appreciated, the spatial dimensions of the incoupling gratings depend on the distance between the entrance pupil and the grating itself. Thus, the spatial dimensions of the gratings may be reduced by bringing the entrance pupil of the system closer to the waveguide. The outcoupling grating dimensions similarly depend on the distance to the exit pupil of the system i.e. the eye relief. Further increasing the number of tiles to more than two further increases the field of view of the system.

FIGS. 3c and 3d both show 2×1 tile arrangements 300c, 300d, which may be two halves of the 2×2 tile arrangement shown in FIG. 3e, whereby each incoupling VPH grating 302a, 302b has a corresponding fold VPH grating 304a, 304b and outcoupling VPH grating 303a, 303b whereby again each individual beam of the light 301a, 301b incoupled by a respective incoupling VPH grating 302a, 302b has only a single available path through the waveguide device to a respective outcoupling VPH grating 303a, 303b. As above, the x, y and z axes indicate generic spatial dimensions of the waveguide device and the distances the light has to propagate therethrough, the exact dimensions being application dependent as will be appreciated by the skilled person. Unlike in FIG. 3b, the footprint of the arrangements in FIGS. 3c and 2d comprises two tiles 305a, 305b arranged adjacent or across from each other. As with FIG. 3b, the light 301a, 301b propagating along the two different paths provides the advantage that there is no or very little cross talk between them. As described above, providing a plurality of sets of VPH gratings in this way allows the full field of view to be divided along one direction, in this case the y-direction. For example, having two sets of tiles allows the field of view along the y-direction to be increased. As will be appreciated, the spatial dimensions of the incoupling gratings depend on the distance between the entrance pupil and the grating itself. Thus, the spatial dimensions of the gratings may be reduced by bringing the entrance pupil of the system closer to the waveguide. The outcoupling grating dimensions similarly depend on the distance to the exit pupil of the system i.e. the eye relief. Further increasing the number of tiles to more than two further increases the field of view of the system. The sets of VPH gratings of FIG. 3c may be provided in a first layer of a waveguide device while the sets of VPH gratings of FIG. 3d may be provided in a second layer of the waveguide device. By stacking these layers in a stack, the waveguide device effectively has a 2×2 tiled arrangement thereby significantly increasing the field of view compared to either the single tile arrangement of FIG. 3a or the 2×1 tile arrangements of FIGS. 3b, 3c, 3d.

FIG. 3e illustratively shows such a 2×2 tiled arrangement comprising the 2×1 tiled arrangements of FIGS. 3c and 3d superimposed on top of each other in a layered stack. The x, y and z axes indicate generic spatial dimensions of the waveguide device and the distances the light has to propagate therethrough, the exact dimensions being application specific as will be appreciated by the skilled person. As described above, advantageously the full field of view is collectively divided among each of the incoupling VPH gratings 302a-d. As is illustrated in FIG. 3e, the footprint of the tiled, stacked arrangement in FIG. 3e comprises four tiles 305a, 305b, 305c, 305d arranged adjacent in a 2×2 array. Of course it is envisaged that other tiling arrangements and shapes are possible including for example, 3×3 or 4×4 or more arrays of tiles.

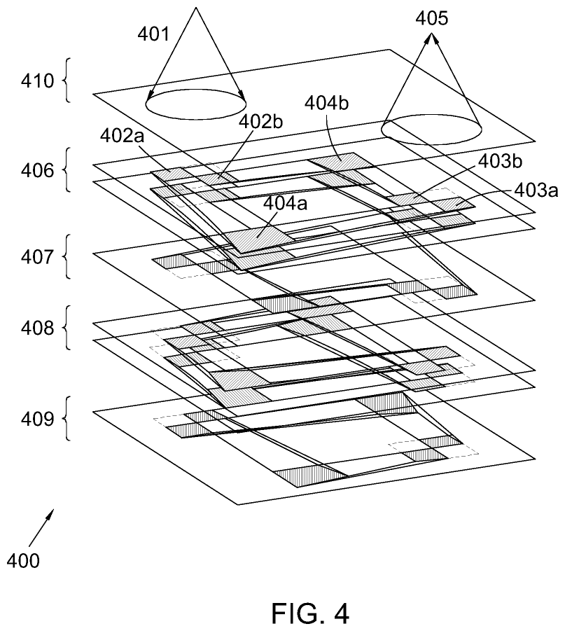

FIG. 4 illustratively shows a stacked layer and tiled arrangement 400 according to the present disclosure. Like-numbered reference numerals refer to like-numbered elements. Each layer comprises one or more sets of tiled arrangements such as that shown in FIG. 3c or 3d and is configured to have not only an angle selectivity but also a wavelength selectivity. In order to assist in readability, only one layer is labelled in FIG. 4, however it will be appreciated that the other layers have corresponding tiled arrangements. For example, in each layer incident light 401 is incoupled through incoupling VPH gratings 402a, 402b. The light propagates through total internal reflection and through fold VPH gratings 404a, 404b until reaching outcoupling VPH gratings 403a, 403b where it is outcoupled and directed to a target eyebox 405. As is shown in FIG. 4, a plurality of such sets may be multiplexed in a single layer 406 whereby each set is configured to be selective according to wavelength. For example, the arrangement of FIG. 4 is envisaged to by polychromatic and have red R, green G, and blue B sets. Specifically, in FIG. 4 the R and B selective VPH gratings may be multiplexed in the same layer 406 whereas the G selective VPH gratings may be in a separate layer 407. These two separate layers may be further stacked on top of corresponding layers 408, 409 having the alternate 2×1 crossed tiling of FIG. 3c or FIG. 3d to provide the 2×2 arrangement of FIG. 3e that provides polychromatic operation in only four layers. Optionally, a protective layer 410 may be provided an outer surface of the stacked layers to protect the material of the VPH gratings. It will be appreciated that other numbers and combinations of layers than that shown in FIG. 4 are also envisaged.

Other effective alternatives will occur to the skilled person. It will be understood that the invention is not limited to the described embodiments and encompasses modifications apparent to those skilled in the art lying within the scope of the claims appended hereto.

For example, it will be understood that a maximal field of view is defined by the system minimal refractive index (between the holographic or waveguide media) whereby the media typically used to record VPH gratings have a refractive index of around 1.51 which contrasts to typical SRG grating material refractive of around 2. As the rays propagate in the waveguide device in total internal reflection, the propagation bandwidth is encompassed at maximum between the total internal reflection limit angle and the evanescence limit angle.

For example, the system described above may have a single exit pupil and be monochromatic or polychromatic. Alternatively, it may have multiple exit pupils generated by pupil expansion and be monochromatic or polychromatic.

For example, the eyebox size can be tailored to the design needs by tuning the VPH material thickness to increase or decrease selectivity and/or by saturating the VPH recording material with exposure during production to decrease selectivity.

For example, it will be appreciated that the present disclosure describes Bragg selectivity tuning to obtain the desired, carefully controlled optical path through the waveguide device. This contrasts to an approach where tuning is based on the optical function of the system.

For example, as described above, a single layer can contain more than three gratings. In the case of colour multiplexing with two different wavelengths injected into the system, a total of six gratings may be needed. For example, to achieve eyebox expansion, multiple fold gratings and outcoupling gratings can be recorded into the same medium to create multiple exit pupils along one or two dimensions. For field of view expansion through tiling, a single layer can also contain multiple tile sets.

For example, in the examples described herein which have only a single incoupling VPH grating, it is envisaged that they are provided with multiple incoupling VPH gratings, for example whereby sets of one incoupling, one fold and one outcoupling VPH grating are provided such that the waveguide device as a whole has a plurality of each type of VPH grating.

For example, the present disclosure primarily envisages use as an optical combiner for the AR/VR use cases such as but not limited to AR glasses, VR headsets or heads-up displays in vehicles.

For example, the surface on which the first, second, and third VPH gratings may variously be provided or laminated may be combinations of the arrangements described herein. For example, the first and third VPH gratings may be laminated on the world side while one or more of the second VPH grating is laminated on the eye or user side. Indeed in such an arrangement one or more other of the second VPH gratings may also be laminated on the world side thus providing an arrangement where some of the second VPH gratings are on the eye or user side while some are on the world side. Any other combination of positioning of the VPH gratings are also envisaged.

For example, the waveguide device of the present disclosure may rely on a varying Bragg condition tailored to accommodate all field-of-view angles for a limited, defined, predetermined spectral bandwidth. This contrasts with known uses of VPH gratings consisting only of plane wave VPHs (with constant surface pitch and fringe period over their surface) whereby all available spectral bandwidth is used to expand the field-of-view. This effect in known systems arises because a plane wave VPH can efficiently diffract a certain wavelength at a certain angle of incidence whereby this paired Bragg condition varies in the angular/spectral phase space. In these cases several efficiency peaks at different lambda or angle-of-incidence pairs are typically apparent. Thus, illuminating such a VPH with a certain spectral bandwidth at different angles ensures that some parts of the spectrum are diffracted everywhere and this allows the field-of-view to be expanded. However, these known techniques have a major drawback, namely they result in different colours being diffracted over different angles of the field-of-view resulting in colour inhomogeneity. Whilst this can be corrected with a colour balance algorithm, it is impractical and requires additional processing resources. Further, to obtain a suitably wide field-of-view, the plane wave VPH needs to be illuminated with a full spectral bandwidth which is hugely lossy because each angle of the field-of-view can only accommodate a limited spectral line defined by the hologram's physical properties. In contrast, the present disclosure's use of providing a varying Bragg condition to accommodate all field-of-view angles for a predetermined spectral bandwidth overcomes this problem as the losses are substantially less.

A further negative consequence of above-described known VPH grating systems is that the light is typically outcoupled indiscriminately. In this regard, the system functions akin to a standard SRG grating whereby the outcoupled light diverges from the outcoupler. In contrast, in the present disclosure, the waveguide outcouples a converging pupil.

Further, in such known VPH grating systems, there is typically no multiplexing to provide pupil replication multiple times as there is in the present disclosure. Even where hologram multiplexing is provided in known systems, field of view is increased by decreasing wavelength and/or angular selectivity. In other words, in such scenarios several plane wave holograms each with slightly different, fixed/constant Bragg conditions are multiplexed, which artificially loosens the overall selectivity condition. In contrast, in the present disclosure, each VPH grating has a varying Bragg condition to enable efficient diffraction of different angles at different positions while keeping a narrow selectivity condition.

Finally, it is envisaged that, in the present disclosure, Y-axis eyebox expansion may be achieved by redirecting X-axis propagation towards a Y direction (or vice-versa for X-axis eyebox expansion) using the plurality of VPH gratings. This contrasts with systems where a Y-direction hologram offsets light in total internal reflection vertically only in the Y-direction (or X-direction hologram offsets light in total internal reflection horizontally in only the X-direction). This ability to redirect Y to X or X to Y direction to achieve eyebox expansion advantageously provides for more complex angular selectivity and thus greater control over the output of the waveguide device compared to known systems.

### LIST OF REFERENCE NUMERALS

100 waveguide device
101a light beam
101b light beam
101c light beam
101d light beam
102 incoupling SRG
103 outcoupling SRG
104 eyebox
105 user
106 wasted light
107 wasted light
108 fold SRG grating
200 waveguide device
201a light beam
201b light beam
202a-d incoupling VPH grating
203a-d outcoupling VPH grating
204a-d eyebox
205 user
206a-d fold VPH grating
300a-e tiled VPH grating arrangement
301a-b light beam
302a-d incoupling VPH grating
303a-d outcoupling VPH grating
304a-b fold VPH grating
305a-d tile footprint
400 stacked layer, tiled arrangement
401 incident light
402a-b incoupling VPH grating
403a-b outcoupling VPH grating
404a-b fold VPH grating
405 outcoupled light
406 multiplexed VPH grating layer
407 single VPH grating layer
408 multiplexed VPH grating layer
409 single VPH grating layer
410 protective layer

1. A waveguide device for generating an eyebox of a display, the waveguide device comprising:
a first volume phase holographic, VPH, grating configured to selectively diffract incident light according to a wavelength and/or an angle of incidence on the first VPH grating to incouple the diffracted incident light into the waveguide device,
one or more second VPH gratings configured to selectively diffract the incoupled light according to a wavelength and/or an angle of incidence to direct the incoupled light through the waveguide device; and
one or more third VPH gratings configured to selectively diffract the light propagating in the waveguide device according to a wavelength and/or an angle of incidence to outcouple said propagating light,
wherein collectively each beam of outcoupled light generates said eyebox.

2. The waveguide device according to claim 1, wherein a Bragg selectivity of the first, second and/or third VPH gratings determines a size of the generated eyebox.

3. The waveguide device according to claim 2, wherein the Bragg selectivity of the first, second and/or third VPH gratings is determined by a thickness of the material first, second and/or third VPH gratings.

4. The waveguide device according to claim 2, wherein the Bragg selectivity of the first, second and/or third VPH gratings is determined by an exposure saturation of the material of the first, second and/or third VPH gratings during manufacture.

5. The waveguide device according to claim 1, wherein a wavelength and/or angle selectivity of the first, second and third VPH gratings provides a single optical path through the waveguide device for each wavelength and/or angle of incidence of a beam of light incident on the first VPH grating.

6. The waveguide device according to claim 1, wherein the first, second and third VPH gratings comprise linear VPH gratings.

7. The waveguide device according to claim 1, wherein at least two of the one or more second VPH gratings are multiplexed together.

8. The waveguide device according to claim 1, wherein at least two of the one or more third VPH gratings are multiplexed together.

9. The waveguide device according to claim 1, wherein the waveguide device defines a plurality of exit pupils, each exit pupil associated with a second and a corresponding third VPH grating.

10. The waveguide device according to claim 1, comprising a plurality of sets of said first, second and/or third VPH gratings.

11. The waveguide device according to claim 10, wherein the plurality of sets of said VPH gratings are provided in a tiled arrangement in the waveguide device.

12. The waveguide device according to claim 11, wherein the pitches and/or pitch orientations of the first, second and/or third VPH gratings in each set of the tiled arrangement are different.

13. The waveguide device according to claim 12, wherein the pitch and/or pitch orientations define a k-vector of each of the first, second and/or third VPH gratings in each set of the tiled arrangements, and wherein the sum of the k-vectors in each set is zero.

14. The waveguide device according to claim 10, wherein each set of VPH gratings is configured to selectively diffract incident light of a different wavelength or wavelength band.

15. The waveguide device according to claim 10, wherein the plurality of sets of VPH gratings are further provided in stacked layers in the waveguide device.

16. The waveguide device according to claim 15, wherein at least two sets of the plurality of sets of VPH gratings are multiplexed in the same layer of a stack.

17. The waveguide device according to claim 1, wherein the first, second and third VPH gratings are arranged at a first surface of the waveguide device.

18. The waveguide device according to claim 17, wherein the first, second and third VPH gratings are laminated on the first surface of the waveguide device.

19. An optical system for a heads-up display, the optical system comprising:
an image projector configured to project an image towards an eye of a user; and
a combiner element comprising the waveguide device of claim 1 positioned in a field of view of the user and in an optical path between the image projector and the eye of the user.

20. The optical system according to claim 19, wherein the first, second and third VPH gratings are laminated on a surface of the combiner element facing away from the user.
